(19) United States
(12) Patent Application Publication
(10) Pub. No.: US 2022/0017137 A1
(43) Pub. Date: Jan. 20, 2022

(54) A NEW GENERATION DUAL-HANDLE STEERING CONSOLE FOR TRACKED MILITARY VEHICLES

(71) Applicant: FNSS SAVUNMA SÍSTEMLERÍ A.S., GÖLBASI (TR)

(72) Inventors: MEHMET ALÍ ÇÍFTÇÍ, GÖLBASI (TR); BURAK DÍBEK, GÖLBASI (TR); ONUR ÖZENER, GÖLBASI (TR)

(21) Appl. No.: 17/275,685

(22) PCT Filed: Sep. 18, 2020
(86) PCT No.: PCT/TR2020/050862

§ 371 Date: Mar. 12, 2021

(30) Foreign Application Priority Data
Oct. 21, 2019 (TR) 2019/16200

(51) Int. Cl. B62D 1/184; B62D 1/04; B62D 1/06; B62D 1/187

(52) U.S. Cl. CPC B62D 1/184; B62D 1/187; B62D 1/06; B62D 1/046

(57) ABSTRACT

The present invention relates to a new generation dual-handle, adjustable steering console used for steering tracked military land vehicles. The present invention, considering the weight of the console, vehicle's condition on the ground, and the confined volume of the driver's cabinet, particularly relates to a new generation dual-handle steering console that comprises a linear motion lock (40), an angular motion lock (50), and a wrist motion lock (60) that allow for individually adjusting the steering console to the best position for the driver.

### TECHNICAL FIELD OF THE INVENTION

The present invention relates to a new generation dual-handle, adjustable steering console used for steering tracked military land vehicles.

The present invention, considering the weight of the console, vehicle's condition on the ground, and the confined volume of the driver's cabinet, particularly relates to a new generation dual-handle steering console that comprises a linear motion lock, an angular motion lock, and a wrist motion lock that allow for individually adjusting the steering console to the best position for the driver.

### STATE OF THE ART

Military vehicle systems undergo significant improvements in parallel with the developments in technology. The primary reason underlying these developments is the intention to make military vehicles faster, more comfortable, practical, and reliable. Due to their nature, tracked vehicles feature an intense vibration profile. Furthermore, the handling of the military vehicle and the loads received by the steering wheel thereof may be at a higher level compared to a normal vehicle due to the use of tracks and land conditions. Therefore, the driver of a military vehicle should be able to handle the military vehicle as comfortably as possible under intense vibrations and loads. Thus, persons skilled in the art continue to make improvements in the relevant technical field in order to facilitate handling these vehicles.

Tracked armored vehicles are capable of performing “pivoting”. Pivoting is a motion where a vehicle performs rotating 360° motion around its own axis. However, in case this motion is performed accidentally, it may be lethal for people around the vehicle. Moreover, tracked vehicles may require fixing the steering wheel at the center while traversing on soft, slippery, or rough terrain.

In the state of the art, wire bends of the drive-by-wire mechanism may produce adverse effects in the operation of the mechanism. In cases where the wires get jammed or hung up, the push-pull solenoid may get burned.

In the state of the art, the driver may adjust the height of the console based on the driving position, either standing or sitting. However, the fixing pin involved in this height adjustment process is used for locking simply by being inserted through the bracket and console. This causes imposing the console weight onto the pin and consequently gives rise to ergonomic difficulties while removing and reinserting the pin. Furthermore, the pin is provided with a redundantly long motion range since it is designed lengthwise. This brings along another difficulty of use.

Steering consoles available in the state of the art do not comprise controllers thereon. Consequently, this renders the console impractical.

Another disadvantage of steering consoles used in the state of the art is that these consoles do not possess linear motion features. Therefore, these consoles cannot be adjusted properly for the user.

Steering consoles used in the state of the art cause deviation in the wrist position of the driver due to the angular elevation of the console.

Furthermore, steering consoles available in the state of the art are quite heavy and bulky.

In the state of the art, the driver's physical and visual access to the vehicle's dashboard is obstructed while driving in standing position.

Consequently, the need for a new generation dual-handle steering console that is cost-efficient, practical, and ergonomic, as well as the inadequacy of available solutions necessitated making an improvement in the relevant technical field in order to provide a solution for the aforementioned problems existing in the state of the art.

### OBJECTS OF THE INVENTION

The present invention relates to a new generation, dual-handle, adjustable steering console that is used for steering tracked military land vehicles, and that is developed in order to eliminate the aforementioned disadvantages and to bring forth further new advantages to the relevant technical field.

The most important object of the present invention is to ensure that the subsystems of the vehicle are controlled by means of both the controllers on the steering wheel and display in the new generation steering console. The present invention allows for controlling the critical systems of the vehicle over the steering wheel, thereby eliminating the need for compromising handling of the vehicle to be able to manage the subsystems of the vehicle. The user not only may view the information regarding the vehicle over the display, but also may obtain footage from the vehicle's cameras when necessary. The steering wheel is provided with controllers that allow for controlling communications, radio, wipers, and similar systems. The selected display in the present invention supports adding an infinite number of pages and is capable of being programmed and of working with the vehicle's subsystems in full cooperation. The console is provided with an electric interface and the internal wiring of the console is designed accordingly for the purpose of controlling the electronic units located on the steering wheel and arranging the software thereof.

Another object of the present invention is to ensure that the driver may select the most appropriate position for the steering wheel for driving in sitting and standing positions as well as the most comfortable position for his/her wrists in terms of ergonomics. Locks of the adjustment mechanism may function separately, and the user does not lose one setting while making another adjustment on the console. Furthermore, all mechanism locks may be controlled singlehandedly. Thus, while the user is making adjustments for the position of the steering wheel with one hand, he/she may also continue maintaining the steering control.

Yet another object of the present invention is to ensure that the steering console may be positioned with 3 different options based on the driver's position by means of the forward-backward, angular (tilt), and wrist adjustment mechanism. The driver will be able to change the position of his/her wrists when he/she has adjusted the height and distance of the steering wheel. An angularly rising steering console, due to the nature of its motion, is not enough for providing full ease of access to drivers of different sizes or drivers in different positions. Therefore, the inventive steering console is provided with a back and forth extension feature in addition to angular elevation. Thus, better ergonomic positioning may be provided.

Yet another object of the present invention is to provide 3 different lock control pieces to the user for all of said adjustment mechanisms. Thus, the driver may perform a different positioning for each setting. 3 different locks are provided for 3 different settings considering the weight of the console in military vehicles, vehicle's condition on the ground, and the limited volume of the driver's cabinet.

Yet another object of the present invention is to create multi-integration interfaces to be able to integrate the steering console into different vehicles. Thus, integration processes may be performed by using appropriate connection holes over the multi-interface plate even if the steering console is positioned in different locations and integrated into different vehicles.

Adjustable, dual-handle new generation steering console developed in order to achieve all objects that are mentioned above and that will become apparent from the following detailed description, wherein said steering console comprises;
a steering wheel (10) comprising; controllers (30) that allow for controlling the critical systems of the vehicle, as well as systems including lighting, communications, radio, wipers, etc. without compromising the handling of the vehicle; a display (20) that allows the user to view and control the information regarding the vehicle while driving the vehicle either by standing or by sitting, and to obtain footage from vehicle cameras when necessary, that supports adding an infinite number of pages, that is programmable and that is capable of functioning in full cooperation with the subsystems of the vehicle;
linear motion lock (40) that allows the user to adjust the position as desired by moving the column forwards and backward by coming out of the hole located on the column inner closure (43), by upwardly moving the fixing pin (42) connected to the handle when the user presses the linear motion lock handle (41), and that does not fix the position when the user releases the handle (41);
an angular motion lock (50) that removes the angular fixing pin (52) from the angular motion positioning gear seat (54) when the user pulls the angular motion lock handle (51) and that fixes the position when the user releases the handle (51) upon moving into the position desired by the user, and;
a wrist motion lock (60) that fixes the lock spring (63) and lock pin (64) by applying pressure thereon at an appropriate position by leaving it in an appropriate position through the hole on the positioning piece (62) by means of releasing the steering wheel (10) for the wrist motion when the user lifts the wrist motion lock handle (61).

Structural and characteristic features of the present invention and all advantages thereof will be understood more clearly by means of the figures described below and by means of the detailed description provided by making references to said figures, therefore the respective evaluation should be conducted by taking said figures and the detailed description into consideration.

### DESCRIPTION OF THE FIGURES

FIG. 1 illustrates the inventive new generation steering console.

FIG. 2 illustrates the steering wheel of the inventive new generation steering console.

FIG. 3 illustrates the inventive new generation steering console.

FIG. 4 illustrates the linear motion lock of the inventive new generation steering console.

FIG. 5 illustrates the angular motion lock of the inventive new generation steering console.

FIG. 6 illustrates the wrist motion lock of the inventive new generation steering console.

FIG. 7 illustrates the steering wheel lock solenoid of the inventive new generation steering console.

FIG. 8 illustrates the controller maintenance hatches of the inventive new generation steering console.

FIG. 9 illustrates the sectional view of the inventive new generation steering console.

FIG. 10 illustrates the wiring integration box and military connectors positioned on the inventive new generation steering console.

FIG. 11 illustrates the multi-integration interface of the inventive new generation steering console.

FIG. 12 illustrates the steering attachments of the inventive new generation steering console.

### REFERENCE NUMERALS

10. Steering Wheel (with Dual Handle)

20. Display (Programmable)

30. Controllers

40. Linear Motion Lock

41. Linear Motion Lock Handle

42. Fixing Pin

43. Column Inner Closure

50. Angular Motion Lock

51. Angular Motion Lock Handle

52. Angular Fixing Pin

53. Angular Lock Spring

54. Angular Motion Positioning Gear

60. Wrist Motion Lock

61. Wrist Motion Lock Handle

62. Wrist Motion Positioning Piece

63. Wrist Motion Lock Spring

64. Wrist Motion Lock Pin

70. Steering Wheel Lock Solenoid

80. Steering Wheel Lock Pin

90. Controller Maintenance Hatches

100. Steering Wheel Tube

110. Steering Wheel Covering

120. Steering Console Multi-Integration Interface

130. Teflon Friction Parts

140. Wiring Integration Box

150. Military Connectors

160. Motion Transmission Block

170. Angular Motion Shaft

180. Outer Main Shaft

190. Inner Main Shaft

200. Column Exit Shaft

### DETAILED DESCRIPTION OF THE INVENTION

In the detailed description provided herein, preferred embodiments of the inventive dual-handle, adjustable new generation steering console are described only to ensure a better understanding of the subject without constituting any limiting effects.

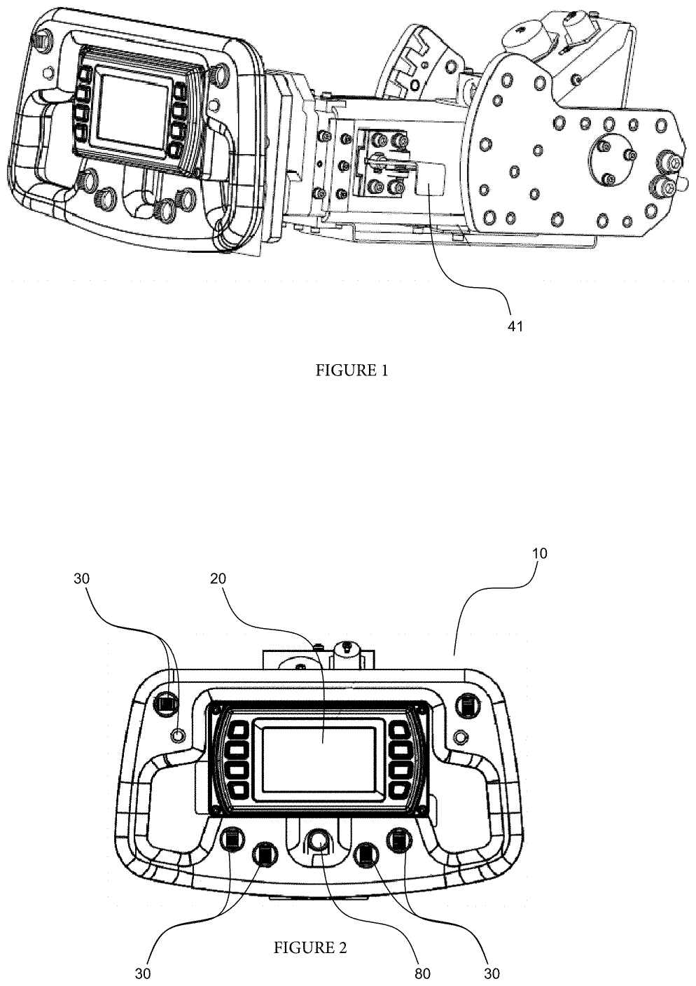

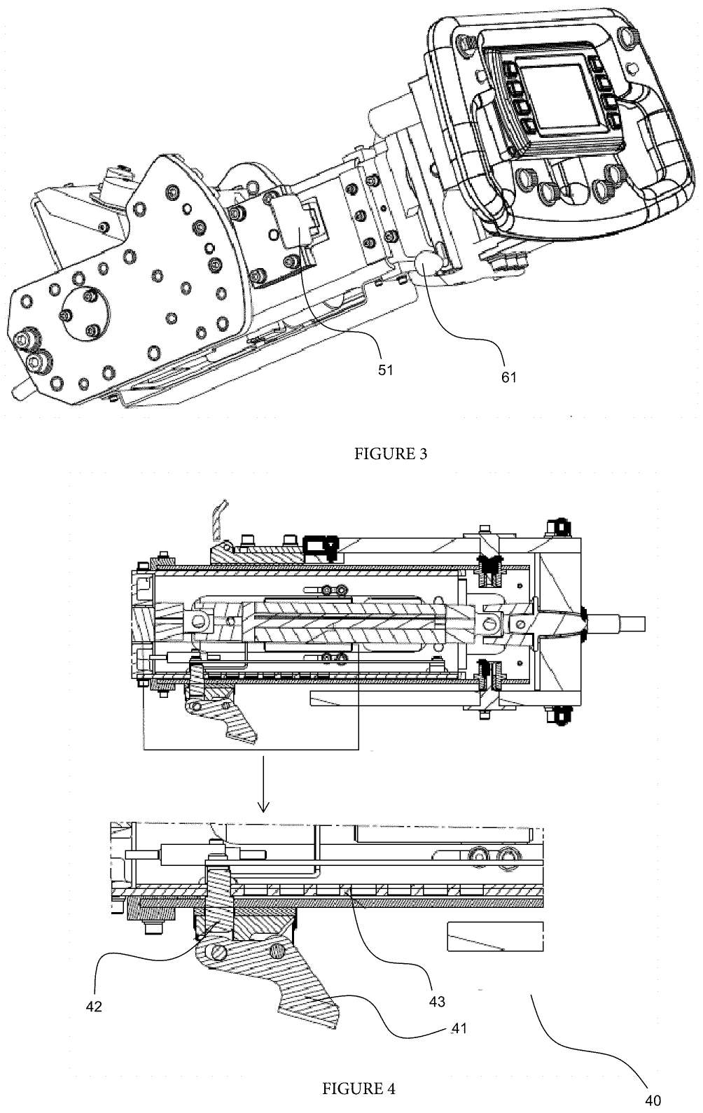

FIG. 1 and FIG. 3 illustrate the inventive new generation steering console. The fact that the position of the steering wheel can be adjusted according to the driver's position in the vehicle has great importance for both vehicle's drive ergonomics and driver's health. This issue gains further prominence when it comes to armored vehicles. Because military vehicles, in addition to being designed to accommodate humans of the smallest standard size to the largest, should enable the user to drive the vehicle when the driver is inside the vehicle or when the driver takes his/her head out of the hatch by rising in his/her seat. Accordingly, this makes the mobility of the steering console crucial.

The steering wheel (10) illustrated in FIG. 2 is a structure that comprises of a number of parts. These parts are; the steering wheel covering (110), steering wheel tube (100), controllers (30) positioned on the steering wheel, and the vehicle display (20) located on the steering wheel. The display (20) positioned on the steering console allows the driver to observe certain systems and conditions in a scenario in which the user drives the vehicle with his/her head out of the vehicle (driving while standing). The selected display (20) in the present invention supports adding an infinite number of pages and is capable of being programmed and of working with the vehicle's subsystems in full cooperation. Controllers (30) provided on the steering wheel (10) in the present invention allow for controlling the critical systems of the vehicle, and the driver does not need to compromise handling to be able to manage the subsystems. The user not only may view the information regarding the vehicle over the display (20), but also may obtain footage from the vehicle's cameras when necessary. The steering wheel (10) is provided with controllers (30) that allow for controlling communications, radio, wipers, and similar systems. Said controllers (30) are positioned on the steering wheel so as to allow the driver to access them without lifting hands when the driver grips the steering wheel. The selected display (20) in the present invention supports adding an infinite number of pages and is capable of being programmed and of working with the vehicle's subsystems in full cooperation. The console is provided with an electric interface and the internal wiring of the console is designed accordingly for the purpose of controlling the electronic units located on the steering wheel and arranging the software thereof.

As can be seen in FIG. 1 and FIG. 3, the present invention comprises 3 different lock mechanisms which are the linear motion lock (40), the angular motion lock (50), and the wrist motion lock (60). Thus, the driver may perform a different positioning for each setting. 3 different lock mechanisms are provided for 3 different settings considering the weight of the console in military vehicles, vehicle's condition on the ground, and the limited volume of the driver's cabinet. Thus, the driver may find the most appropriate position for the steering wheel for driving in sitting and standing positions as well as the most comfortable position for his/her wrists in terms of ergonomics. Furthermore, all mechanism locks may be controlled singlehandedly. Thus, while the user is making adjustments for the position of the steering wheel with one hand, he/she may also continue maintaining the steering control.

FIG. 4 illustrates the linear motion lock (40). When the user presses the linear motion lock handle (41), the fixing pin (42) connected thereto moves upwards and comes out of the hole located on the column inner closure (43). When the user finds the desired position by moving the column forwards and backward, the user releases the handle, thereby fixing his/her position.

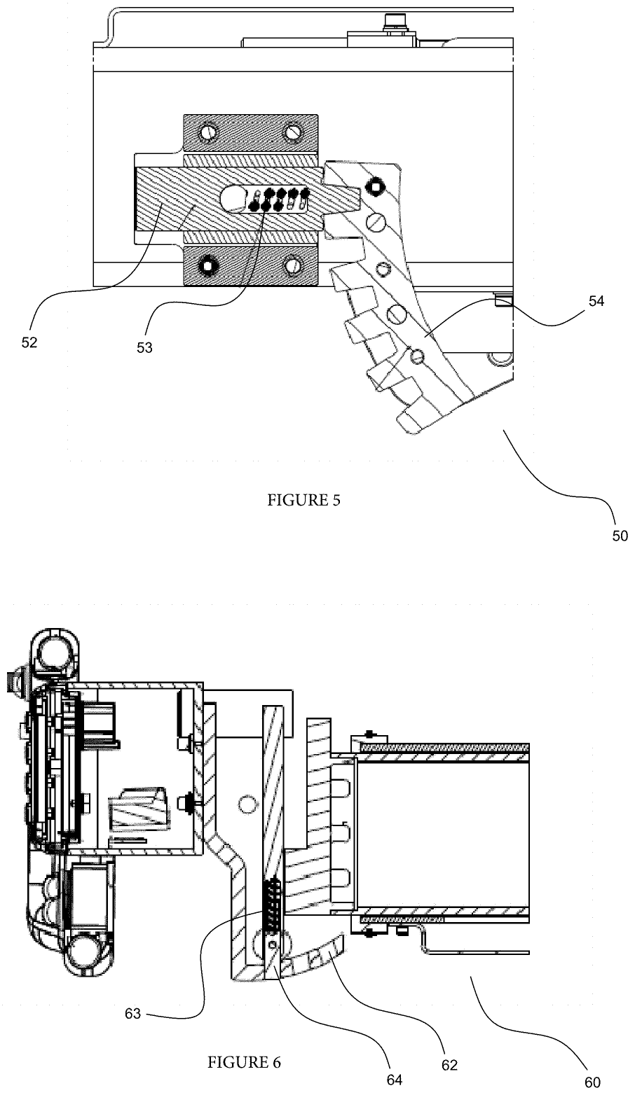

FIG. 5 illustrates the angular motion lock (50). When the driver pulls the angular motion lock handle (51) in order to make an angular adjustment, the angular fixing pin (52) comes out of the angular motion positioning gear seat (54) and the user releases the handle (51) in order to fix his/her position after finding the most appropriate position for himself/herself. The angular lock spring (53) inside the lock ensures that the setting is not lost unintentionally by compressing the pin (52) at the locking point.

FIG. 6 illustrates the wrist motion lock (60). The user lifts the wrist motion lock handle (61) and releases the steering wheel (10) for wrist motion. The positioning piece (62) leaves it in an appropriate position through the holes located thereon, and the lock pin (64) may be fixed at the desired position by applying pressure by means of the lock spring (63).

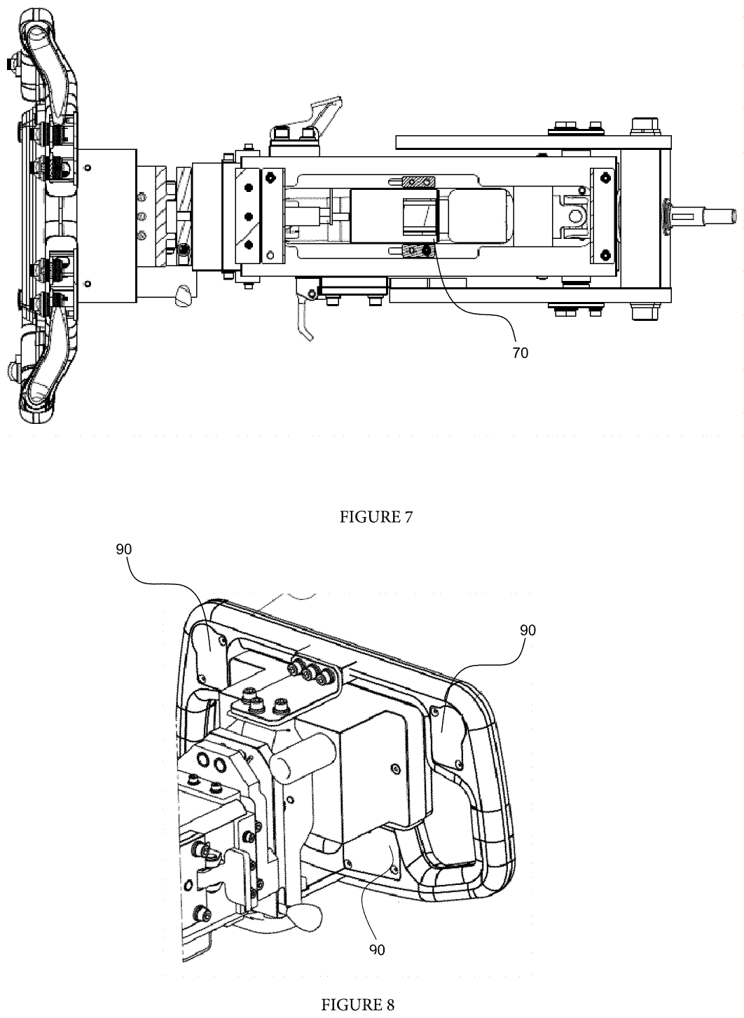

In some cases, it is necessary to fix the steering wheel at the center in order to facilitate and contribute to the handling of the vehicle. Therefore, the column comprises a mechanism that locks the steering wheel (10) at the center. As seen in FIG. 7, the steering wheel lock pin (80) is driven by means of a solenoid (70) positioned into the steering console. The pin (80) is removed from its socket and inserted into the hole located on the steering wheel (10). Thus, the steering wheel (10) is prevented from rotating so long as the lock pin (80) remains within this hole.

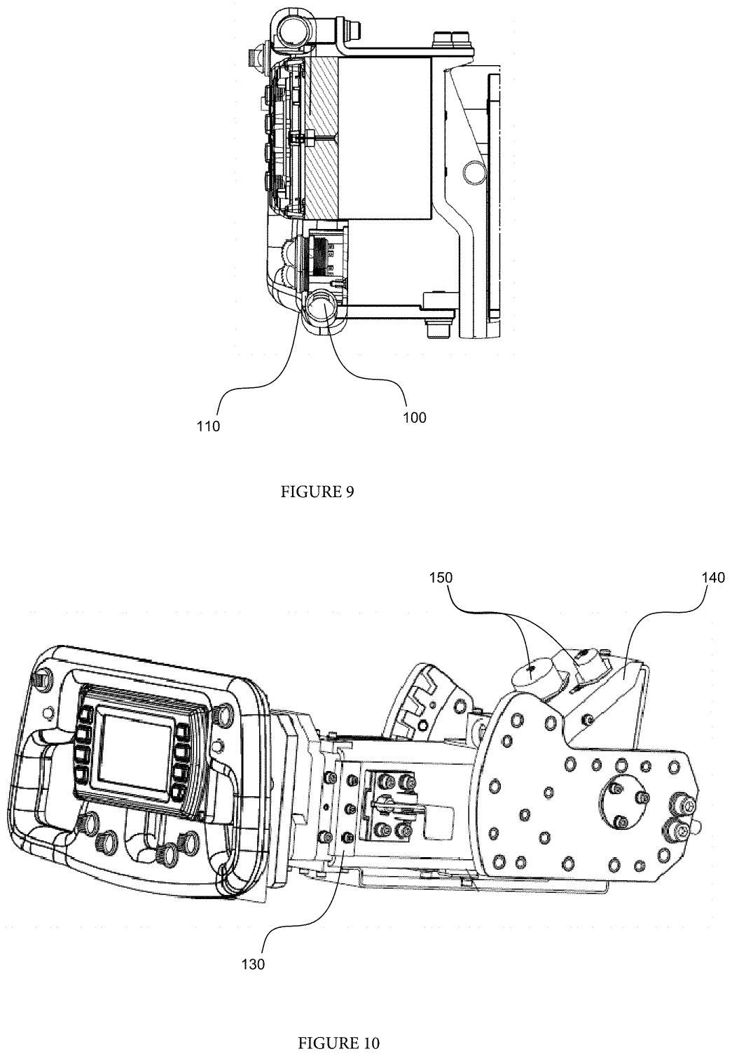

As illustrated in FIG. 8, four maintenance hatches (90) are provided to be able to maintain, repair, assemble and disassemble the controllers (30) positioned on the steering wheel (10). These hatches (90) may be opened when necessary, thereby providing access to the electrical equipment located inside. This eliminates the necessity for disassembling the entire steering wheel (10) to be able to perform maintenance or a disassembly-assembly operation. As seen in FIG. 9, inserting a tube (100) into the steering wheel not only improves the durability of the steering wheel (10) but also provides a safe conduit for passing the wires therethrough. In the steering wheel (10), the covering material (110) manufactured as a shell from a durable material is cladded onto the tube (100). Thus, the outer shell of the steering wheel (10) is provided with an anti-slip feature for the driver.

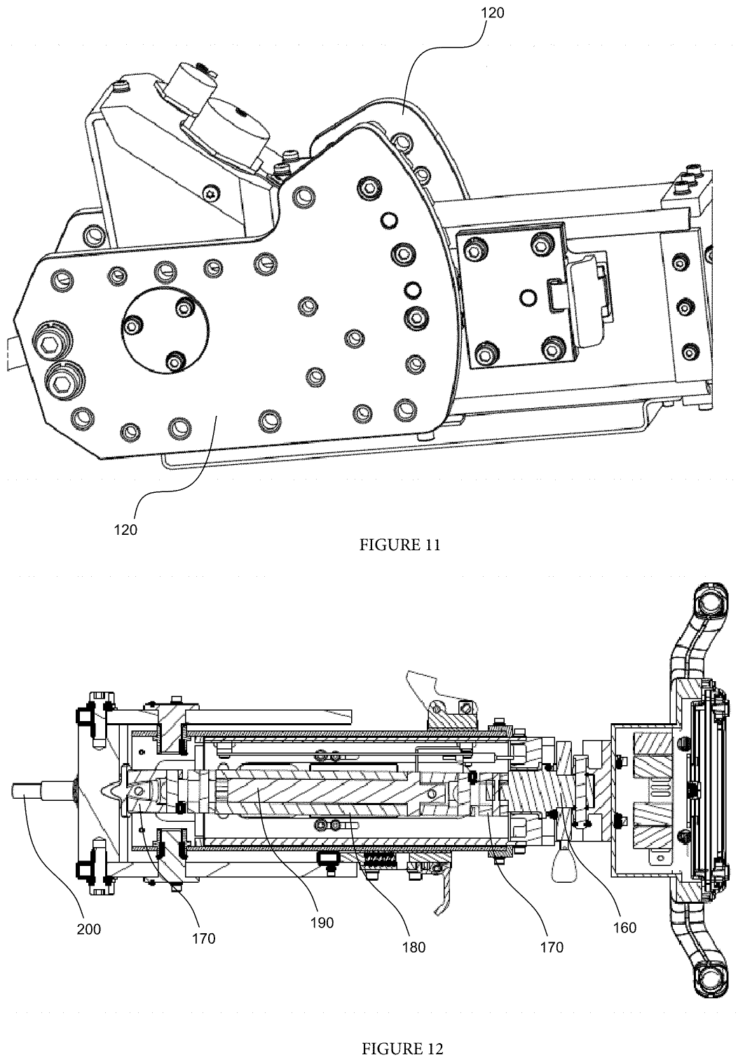

The present invention is designed as a structure that may be used in all tracked vehicles. Therefore, the present invention is equipped with multiple connection interface plates (120) as seen in FIG. 11 so as to integrate it into all types of vehicles without making any changes. As seen in FIG. 10, the present invention is further equipped with two connectors (150) that control the console electronics, in order to ensure ease of compatibility with wiring systems of all vehicles. A box (140) is designed to house these connectors and to protect the sagging wires therein.

Two nested main closure pieces function in the linear motion in the steering console. As seen in FIG. 10, friction parts (130), preferably manufactured from Teflon, are used in order to avoid metal-metal rubs between these two pieces, and any deformations that may potentially arise from rubbing are avoided.

FIG. 12 illustrates the shafts (160, 170, 180, 190, 200) located on the steering console. The steering wheel (10) is connected to said shafts (160, 170, 180, 190, 200) located within the steering console by means of mechanical parts. When the user performs a movement with the steering wheel, said shafts (160, 170, 180, 190, 200) transmit the motion to the steering system at the outlet of the console. The present invention comprises two special shafts (180, 190) that are nested within one another, and that move each other by enabling linear elongation. A motion transmission block (160) ensures that the steering applied to the steering wheel (10) is transmitted to the inner shafts of the column. The angular motion shaft (170) allows for transmitting the steering received from the steering wheel. They are capable of transmitting the same motion even if they move angularly. The outer main shaft (180) and the inner main shaft (190) are the components that enable the transmission of steering received from the steering wheel by allowing linear motion. The column exit shaft (200) is positioned at the end of the steering console and is the interface shaft that transmits the steering received from the driver to the vehicle's steering system.

The protection scope of this application is defined in the pending patent claims, and therefore cannot be limited to the details described above for illustrative purposes only, moreover, it is obvious that a person skilled in the art can set forth the novelty of the present invention by taking advantage of similar embodiments, and/or adapt this embodiment to other fields having similar purposes in the relevant technical field. Therefore, it is clear that such embodiments will lack the novelty criteria, and particularly the criteria of surpassing the state of the art.

1. A dual-handle, adjustable, new generation steering console used for steering tracked military land vehicles, characterized by comprising;
at least one steering wheel (10) comprising; controllers (30) that allow for controlling the critical systems of the vehicle, as well as systems including lighting, communications, radio, wipers, etc. without compromising the handling of the vehicle; a display (20) that allows the user to view and control the information regarding the vehicle while driving the vehicle either by standing or by sitting, and to obtain footage from vehicle cameras when necessary, that supports adding an infinite number of pages, that is programmable and that is capable of functioning in full cooperation with the subsystems of the vehicle;
at least one linear motion lock (40) that allows the user to adjust the position as desired by moving the column forwards and backward by coming out of the hole located on the column inner closure (43), by upwardly moving the fixing pin (42) connected to the handle when the user presses the linear motion lock handle (41), and that does not fix the position when the user releases the handle (41);
at least one angular motion lock (50) that removes the angular fixing pin (52) from the angular motion positioning gear seat (54) when the user pulls the angular motion lock handle (51) and that fixes the position when the user releases the handle (51) upon moving into the position desired by the user, and;
at least one wrist motion lock (60) that fixes the lock spring (63) and lock pin (64) by applying pressure thereon at an appropriate position by leaving it in an appropriate position through the hole on the positioning piece (62) by means of releasing the steering wheel (10) for the wrist motion when the user lifts the wrist motion lock handle (61).

2. Dual-handle, adjustable, new generation steering console according to claim 1, characterized by comprising; an angular lock spring (53) in the angular motion lock (50), wherein said angular lock spring compresses the angular fixing pin (52) in the angular motion positioning gear seat (54), thereby preventing any unintentional adjustment losses.

3. Dual-handle, adjustable, new generation steering console according to claim 1, characterized by comprising; a lock pin (80) that is driven by a solenoid (70) inserted into the steering console, and that prevents the rotation of the steering wheel (10) by entering the hole located thereon.

4. Dual-handle, adjustable, new generation steering console according to claim 1, characterized by comprising; maintenance hatches (90) that allow for performing maintenance, repair, assembly, and disassembly operations by providing access to electrical equipment located therein without the need for disassembling the entire steering wheel (10).

5. Dual-handle, adjustable, new generation steering console according to claim 1, characterized by comprising; a steering wheel tube (100) that improves the durability of the steering wheel (10) and that creates a safe conduit for the wires located therein.

6. Dual-handle, adjustable, new generation steering console according to claim 1, characterized by comprising; a steering wheel covering (110) that is cladded onto the steering wheel tube (100), thereby providing an anti-slip feature to the steering wheel (10) for the driver.

7. Dual-handle, adjustable, new generation steering console according to claim 1, characterized by comprising; multiple connection interface plates (120) that allow for integrating the steering console into all types of tracked vehicles without making any changes.

8. Dual-handle, adjustable, new generation steering console according to claim 1, characterized by comprising; a connector (150) that controls the console electronics so as to provide ease of compatibility with vehicle wiring systems in all tracked vehicles and a box (140) that protects the wires therein by retaining said connector (150).

9. Dual-handle, adjustable, new generation steering console according to claim 1, characterized by comprising; an outer main shaft (180) and an inner main shaft (190) that enable the transmission of the steering received from the steering wheel by allowing linear motion.

10. Dual-handle, adjustable, new generation steering console according to claim 1, characterized by comprising; friction parts (130) that are preferably manufactured from Teflon material and that allow the rubbing of the nested two closures without coming into contact with one another in the linear motion of the steering wheel.
